(19) United States
(12) Patent Application Publication
(10) Pub. No.: US 2026/0355926 A1
(43) Pub. Date: Nov. 12, 2026

(54) Method for operating a work apparatus, and work apparatus

(71) Applicant: Andreas Stihl AG & Co. KG, Waiblingen (DE)

(72) Inventors: Tim Vogt, Schwäbisch Gmünd (DE); Christopher Tost, Auenwald (DE); Thomas Friedrich, Remshalden (DE); Johannes Alber, Stuttgart (DE); Philipp Plappert, Oeffingen (DE)

(73) Assignee: Andreas Stihl AG & Co. KG, Waiblingen (DE)

(21) Appl. No.: 19/673,168

(22) Filed: May 11, 2026

(30) Foreign Application Priority Data
May 12, 2025 (DE) 102025118107.1

(51) Int. Cl. B25F 5/02; H02P 3/02; H02P 3/14; B23D 59/02

(52) U.S. Cl. CPC B25F 5/02; H02P 3/02; H02P 3/14; B23D 59/02

(57) ABSTRACT

A work apparatus (1) has a tool (8), an electric motor (10) for driving the tool (8), a controller (12) for controlling the electric motor (10), an operating element (6) to be actuated by an operator for controlling the electric motor (10), and a blocking element (5) to be actuated by the operator. In a non-actuated position (18), the blocking element (5) blocks control of the electric motor (10) via the operating element (6). In an actuated position (19), the blocking element (5) permits control of the electric motor (10) via the operating element (6). The controller (12) electrically brakes the electric motor (10) during a braking event. During the braking event, the electric motor (10) is controlled depending on whether the blocking element (5) is in the non-actuated position (18) or in the actuated position (19).

### CROSS-REFERENCE TO RELATED APPLICATION

This application claims the benefit of German Patent Application DE 102025118107.1, filed on May 12, 2025, the entire content of which is incorporated by reference.

### TECHNICAL FIELD

The disclosure relates to a method for operating a work apparatus, and to a work apparatus, in particular a handheld power tool.

### BACKGROUND

EP 4 219 081 A1 discloses a work apparatus having a tool and an electric motor for driving the tool. An operating element, which is mounted on a handle of the work apparatus, is provided for actuating the drive motor. The work apparatus also has, on the handle, a blocking element which, in a non-actuated position, mechanically blocks actuation of the operating element.

### SUMMARY

In one aspect, the present disclosure provides an advantageous method for operating a work apparatus. The work apparatus includes a tool, an electric motor for driving the tool, and a controller for controlling the electric motor. In another aspect, the present disclosure provides a work apparatus having advantageous properties.

The controller is configured to electrically brake the electric motor during a braking event.

It has been found that, when the work apparatus is set down, strong braking of the tool can cause movement of the work apparatus due to the inertia of the tool. Such movement is undesirable when the work apparatus is set down. When the operator is holding the work apparatus, movement of the work apparatus is prevented by the operator. When the operator is holding the work apparatus in his hand, the tool should be braked as quickly as possible during a braking event.

In the actuated position of the blocking element, the operator usually holds the work apparatus at a handle on which the blocking element is mounted. Based on actuation of the blocking element, it can therefore be determined whether an operator is holding the work apparatus or whether the work apparatus has been set down. During a braking event, the electric motor is controlled depending on whether the blocking element is in the non-actuated position or in the actuated position. Accordingly, the electric motor is controlled differently during the braking event depending on the position of the blocking element. In particular, different decelerations of the tool can be achieved over at least part of the braking process depending on the position of the blocking element.

The braking event is, in particular, an operating state of the work apparatus in which the tool is to be braked. The braking event occurs in particular when the operator does not actuate the operating element, for example when the operator releases the operating element. In particular, the controller controls the electric motor for electrical braking when the operator does not actuate the operating element. During the braking event, the electric motor is operated in particular as an electrical generator.

In particular, the work apparatus does not have a mechanical braking device. Braking of the tool is carried out in particular only by the electric motor controlled for electrical braking.

In particular, less intense braking is provided when the blocking element is not actuated than when the blocking element is actuated. As a result, very rapid braking can be carried out when the blocking element is actuated, while, when the blocking element is not actuated, that is, in particular when the work apparatus has been set down, movement of the work apparatus due to the inertia of the tool can be prevented.

In particular, during the braking event, the electric motor is controlled with a first braking control strategy which causes the tool to be braked from a rated speed to a specified braking speed in a first braking time when the blocking element is in the actuated position. During the braking event, the electric motor is controlled in particular with a second braking control strategy which causes the tool to be braked from the rated speed to the specified braking speed in a second braking time. The first and second braking times are measured under identical conditions, that is, in particular with respect to the same tool, the same rated speed, and the same specified braking speed. The second braking time is in particular longer than the first braking time.

In particular, the tool is completely electrically braked. The specified braking speed corresponds in particular to standstill of the tool. However, it may also be provided that a braking speed greater than zero is acceptable, such that the tool is not completely braked. Accordingly, a braking speed greater than zero may also be provided.

In order to implement the different braking control strategies in a simple manner, it is provided in particular that a higher maximum motor current is set in the first braking control strategy than in the second braking control strategy. By setting the higher maximum motor current, faster braking of the electric motor can be achieved.

The work apparatus comprises in particular a battery. The energy generated in the electric motor during the braking event is in particular at least partially fed into the battery. Depending on the permissible current intake of the battery, the battery can have a limiting effect on the deceleration of the tool over at least part of the braking process. It may therefore be provided that, for part of the braking process, in particular for a part of the braking process adjoining the rated speed, the same deceleration is achieved in the first braking control strategy and in the second braking control strategy. However, in particular when the rotational speed of the tool has already decreased, the maximum current intake of the battery and the maximum permissible motor currents of the first braking control strategy and the second braking control strategy are selected such that different decelerations result in the first braking control strategy and in the second braking control strategy. In this way, different braking times can be achieved in a simple manner for the first braking control strategy and the second braking control strategy, even under otherwise identical conditions.

It may be provided that a portion of the energy generated in the electric motor during the braking event is not fed into the battery. As a result, the current intake of the battery can be reduced. The energy not fed into the battery can be supplied to another consumer and/or converted into heat.

For a work apparatus having a tool, an electric motor for driving the tool, a controller for controlling the electric motor, an operating element configured to be actuated by an operator for controlling the electric motor, and a blocking element configured to be actuated by the operator, wherein the blocking element, in a non-actuated position, blocks control of the electric motor via the operating element and, in an actuated position, permits control of the electric motor via the operating element, it is provided that at least one first braking control strategy and at least one second braking control strategy for electrically braking the electric motor are stored in the controller. The controller is configured to control the electric motor during the braking event with the first braking control strategy or with the second braking control strategy depending on whether the blocking element is in the non-actuated position or in the actuated position.

The first braking control strategy causes in particular braking of the tool from a rated speed to a specified braking speed in a first braking time. The second braking control strategy causes in particular braking of the tool from the rated speed to the specified braking speed in a second braking time. The second braking time is in particular longer than the first braking time. The controller is configured to control the electric motor with the second braking control strategy when the blocking element is in the non-actuated position. This results in a longer braking time when the blocking element is in the non-actuated position, in particular when the work apparatus has been set down. When the blocking element is in the actuated position, the controller controls the electric motor in particular with the first braking control strategy.

It may be provided that the work apparatus has further braking control strategies for further operating cases. The further braking control strategies may be provided when further criteria are present with the blocking element in the non-actuated and/or actuated position.

In particular, in the non-actuated position, the blocking element mechanically blocks the operating element. However, it may also be provided that, in the non-actuated position, the blocking element electrically prevents control of the electric motor via the operating element, for example by electrically detecting the position of the blocking element, processing the position accordingly in the controller, and preventing starting of the electric motor when the blocking element is not actuated.

In particular, the blocking element acts on a switch connected to the controller. In particular, the blocking element actuates the switch in the non-actuated position.

Different braking control strategies are advantageous in particular in work apparatuses having a tool with a high mass moment of inertia. In particular, the work apparatus is a cut-off machine, and the tool is a cutting wheel.

### BRIEF DESCRIPTION OF THE DRAWINGS

An exemplary embodiment of the invention is explained below with reference to the drawings, in which:

FIG. 1 shows a side view of a work apparatus.

FIG. 2 shows a perspective illustration of the region of the handle of the work apparatus, wherein one handle half-shell has been removed and wherein a water connection is additionally illustrated.

FIG. 3 shows a partial sectional illustration of the region of the operating element and the blocking element of the work apparatus from FIG. 1 with the blocking element not actuated and the operating element not actuated.

FIG. 4 shows a sectional illustration corresponding to FIG. 3 with the blocking element actuated and the operating element actuated.

FIG. 5 shows a schematic illustration of the sequence of the method for controlling the work apparatus.

FIG. 6 shows schematic diagrams of the profile of torque, rotational speed, and power over time for different braking control strategies of the electric motor of the work apparatus.

### DETAILED DESCRIPTION

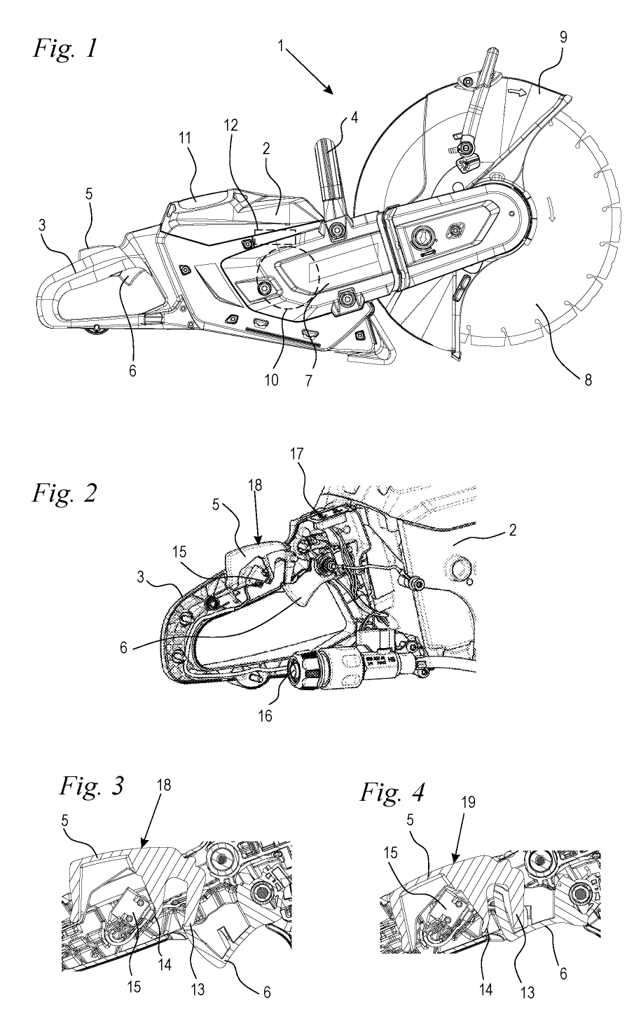

FIG. 1 shows a work apparatus 1. The work apparatus 1 is a hand-guided, hand-carried work apparatus. In the exemplary embodiment, the work apparatus 1 is a cut-off machine. However, the work apparatus 1 may also be another work apparatus. In particular, the work apparatus 1 is a work apparatus having a rotating tool, in particular a rotating tool having a large mass moment of inertia.

The work apparatus 1 has a housing 2 on which a handle 3 and a handle tube 4 are arranged. A blocking element 5 and an operating element 6 are arranged on the handle 3. The blocking element 5 serves for operator presence control. If an operator holds the handle 3 with his hand, he thereby in particular actuates the blocking element 5. Without actuation of the blocking element 5, control of a tool 8 of the work apparatus 1 by actuation of the operating element 6 is in particular not possible.

A cantilever arm 7 is arranged on the housing 2. The tool 8 is rotatably mounted on the cantilever arm 7. In the exemplary embodiment, the tool 8 is a cutting wheel. The tool 8 is surrounded over part of its circumference by a protective hood 9. In another type of work apparatus 1, another arrangement of the tool 8 may be provided.

For driving the tool 8, the work apparatus 1 has an electric motor 10 arranged in the housing 2. A battery 11 is arranged in the housing 2 for supplying energy to the electric motor 10. The battery 11 is in particular held exchangeably in the housing 2. A controller 12, which is likewise arranged in the housing 2, is provided for controlling the electric motor 10.

FIG. 2 shows the blocking element 5 in a non-actuated position 18. In this position, the operator in particular does not grip the handle 3. The blocking element 5 is in particular in the non-actuated position 18 when the work apparatus 1 has been set down. FIG. 2 also shows a water connection 16 for supplying the tool 8 with water for cooling and for binding the dust generated during cutting.

A switch 15 is arranged adjacent to the blocking element 5. In the non-actuated position 18 of the blocking element 5, the switch 15 is actuated in the exemplary embodiment. The work apparatus 1 also has an activation element 17. The activation element 17 may be, for example, a switch or a touchscreen. In order to be able to put the electric motor 10 into operation with the operating element 6, in particular the activation element 17 must first be actuated and then, within a specified, comparatively short time period thereafter, the blocking element 5 must be actuated.

FIG. 3 shows the arrangement of the blocking element 5 and the operating element 6 in detail. The blocking element 5 has an actuating portion 14 which actuates the switch 15 in the non-actuated position 18 of the blocking element 5. The blocking element 5 also has a blocking portion 13. In the non-actuated position 18 of the blocking element 5, the blocking portion 13 is located in the pivot path of the operating element 6. The blocking portion 13 mechanically blocks the operating element 6.

FIG. 4 shows the blocking element 5 in an actuated position 19. In this position, the blocking portion 13 is not located in the pivot path of the operating element 6. In FIG. 4, the operating element 6 is shown in a fully actuated position. The actuating portion 14 is arranged at a distance from the switch 15 and does not actuate the switch 15.

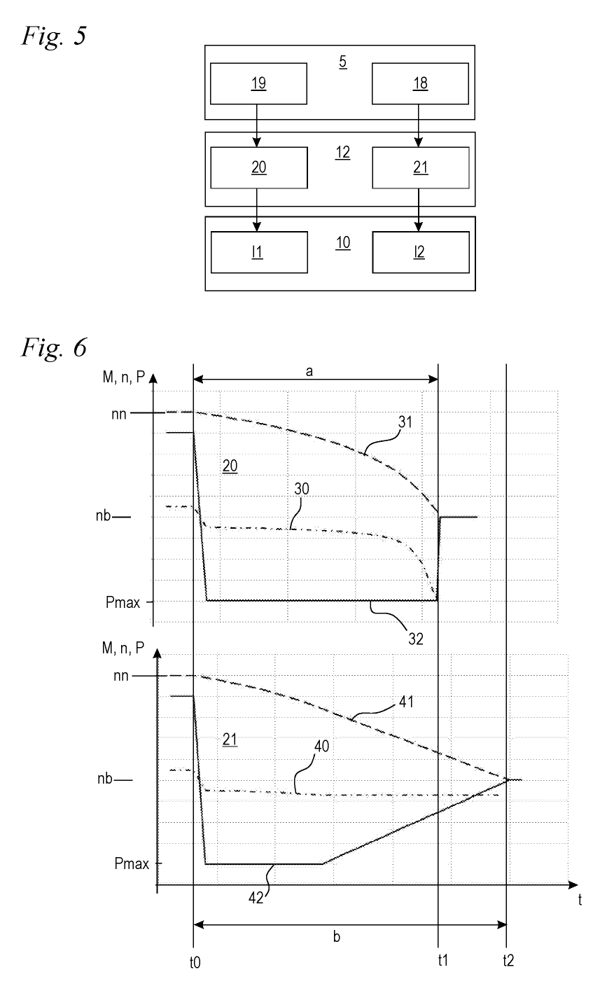

As shown in FIG. 5, a first braking control strategy 20 and a second braking control strategy 21 are stored in the controller 12. The braking control strategies 20 and 21 differ in the deceleration of the electric motor 10 or of the tool 8 during the braking event. In the exemplary embodiment, it is provided that, in order to achieve different decelerations in the braking control strategies 20 and 21, different maximum motor currents I1 and I2 are provided. In the first braking control strategy 20, a first, comparatively high maximum motor current I1 is provided. In the second braking control strategy 21, a second, lower maximum motor current I2 is provided. The second maximum motor current I2 may be, for example, 0.1 times to 0.6 times the first maximum motor current I1.

In the exemplary embodiment, it is provided that, in the braking event, the controller 12 selects the first braking control strategy 20 or the second braking control strategy 21 depending on whether the blocking element 5 is in the non-actuated position 18 or the actuated position 19.

If the blocking element is in the actuated position 19, the first braking control strategy 20 is selected by the controller 12. When the blocking element 5 is in the actuated position 19, the operator usually grips around the handle 3 and thereby holds the work apparatus 1. In the first braking control strategy 20, the maximum motor current of the electric motor 10 is limited to a first maximum motor current I1 which is comparatively high.

In FIG. 6, the upper diagram schematically illustrates the profile of the torque M of the electric motor 10 by a curve 30. The rotational speed n of the electric motor 10 is schematically illustrated by a curve 31. The braking power P is schematically illustrated by a curve 32. A braking process begins at a time t0. The braking process is initiated in particular when an operator releases the operating element 6. The rotational speed n at the time t0 corresponds in the diagram to a rated speed nn. According to the curve 32, the braking power P very quickly reaches a maximum braking power Pmax. According to the curve 31, the rotational speed n drops comparatively quickly from the rated speed nn to a braking speed nb. The braking speed nb may be, for example, zero and thus correspond to standstill of the electric motor 10 and the tool 8. As shown in the upper diagram of FIG. 6, the curve 30, which indicates the torque M, initially remains approximately constant and then drops very quickly at lower rotational speeds n. The first braking time a from the first time t0 to a second time t1, at which the braking speed nb is reached, is comparatively short.

As shown in FIG. 5, the controller 12 selects the second braking control strategy 21 when the blocking element 5 is in its non-actuated position 18. In this state, the work apparatus 1 has usually been set down, or the operator is not holding the handle 3 in the manner intended for operation. According to the second braking control strategy 21, the maximum motor current is limited to a second maximum motor current I2. The second maximum motor current I2 is significantly smaller than the first maximum motor current I1.

In FIG. 6, the lower diagram schematically illustrates the profile of torque M, rotational speed n, and braking power P of the electric motor 10 when the electric motor 10 is controlled according to the second braking control strategy 21. The profile of the torque M is illustrated by a curve 40. As shown in FIG. 6, the torque M remains substantially constant when the electric motor 10 is controlled according to the second braking control strategy 21 until the braking speed nb is reached. The curve 41 shows the profile of the rotational speed n. At lower rotational speeds n, the rotational speed n falls less sharply than when the electric motor 10 is controlled according to the first braking control strategy 20, as shown by a comparison of the curve 41 with the curve 31.

The profile of the braking power P is schematically illustrated by a curve 42. As shown in FIG. 6, the electric motor 10 is initially also braked with the maximum braking power Pmax when controlled according to the second braking control strategy 21, as shown by the curve 42. However, the braking power P decreases over the course of the braking process. At a third time t2, which is after the second time t1, the rotational speed n has reached the braking speed nb, for example standstill of the tool 8 and of the electric motor 10. A second braking timeb, which is greater than the first braking time a, elapses from the first time t0 to the third time t2. The second braking timeb may be, for example, 5% to 150% greater than the first braking time a.

In both braking control strategies 20 and 21, the energy generated in the electric motor 10 is fed back into the battery 11 (FIG. 1). During the braking event, the electric motor 10 is operated as a regenerative brake or recuperative brake. The maximum braking power Pmax is therefore limited by the maximum power intake of the battery 11. In the first braking control strategy 20, the braking process is carried out at the maximum braking power Pmax over the majority of the braking time a. In the second braking control strategy 21, the braking process is carried out at the maximum braking power Pmax only at the beginning of braking, for example over 10% to 60% of the second braking timeb. This results in the second braking timeb, which is increased relative to the first braking time a.

It may also be provided that at least a portion of the energy generated in the electric motor 10 is not fed back into the battery 11. The energy not fed back into the battery 11 can in particular be supplied to another consumer or converted into heat.

The braking times a and b relate to the same tool 8, the same rated speed nn at the beginning of the braking process, and the same braking speed nb at the end of the braking process. Other parameters of the work apparatus 1 are also in particular the same for the comparison of the braking times a and b.

What is claimed is:

1. A method for operating a work apparatus (1),
the work apparatus (1) including a tool (8), an electric motor (10) for driving the tool (8), a controller (12) for controlling the electric motor (10), an operating element (6) configured to be actuated by an operator for controlling the electric motor (10), and a blocking element (5) configured to be actuated by the operator,
the method comprising:
blocking, by the blocking element (5) in a non-actuated position (18), control of the electric motor (10) by the operating element (6);
permitting, by the blocking element (5) in an actuated position (19), control of the electric motor (10) by the operating element (6);
electrically braking, by the controller (12), the electric motor (10) during a braking event; and
controlling, during the braking event, the electric motor (10) depending on whether the blocking element (5) is in the non-actuated position (18) or in the actuated position (19).

2. The method according to claim 1, wherein controlling the electric motor (10) in the braking event comprises:
controlling the electric motor (10) with a first braking control strategy (20) that causes braking of the tool (8) from a rated speed (nn) to a specified braking speed (nb) in a first braking time (a) when the blocking element (5) is in the actuated position (19); and
controlling the electric motor (10) with a second braking control strategy (21) that causes braking of the tool (8) from the rated speed (nn) to the specified braking speed (nb) in a second braking time (b),
wherein the second braking time (b) is longer than the first braking time (a).

3. The method according to claim 2,
wherein the specified braking speed (nb) corresponds to standstill of the tool (8).

4. The method according to claim 2,
wherein the first braking control strategy (20) sets a higher maximum motor current than the second braking control strategy (21).

5. The method according to claim 4,
wherein the work apparatus (1) comprises a battery (11), and
wherein the method comprises at least partially feeding energy generated in the electric motor (10) into the battery (11) during the braking event.

6. A work apparatus (1), comprising:
a tool (8);
an electric motor (10) configured to drive the tool (8);
a controller (12) configured to control the electric motor (10);
an operating element (6) configured to be actuated by an operator for controlling the electric motor (10); and
a blocking element (5) configured to be actuated by the operator,
wherein the blocking element (5), in a non-actuated position (18), blocks control of the electric motor (10) via the operating element (6),
wherein the blocking element (5), in an actuated position (19), permits control of the electric motor (10) via the operating element (6),
wherein at least one first braking control strategy (20) and at least one second braking control strategy (21) for electrically braking the electric motor (10) are stored in the controller (12), and
wherein the controller (12) is configured to control the electric motor (10), during a braking event, with the first braking control strategy (20) or with the second braking control strategy (21) depending on whether the blocking element (5) is in the non-actuated position (18) or in the actuated position (19).

7. The work apparatus (1) according to claim 6,
wherein the first braking control strategy (20) causes braking of the tool (8) from a rated speed (nn) to a specified braking speed (nb) in a first braking time (a),
wherein the second braking control strategy (21) causes braking of the tool (8) from the rated speed (nn) to the specified braking speed (nb) in a second braking time (b),
wherein the second braking time (b) is longer than the first braking time (a), and
wherein the controller (12) is configured to control the electric motor (10) with the second braking control strategy (21) when the blocking element (5) is in the non-actuated position (18).

8. The work apparatus (1) according to claim 6,
wherein the blocking element (5), in the non-actuated position (18), mechanically blocks the operating element (6).

9. The work apparatus (1) according to claim 6,
wherein the blocking element (5) acts on a switch (15) connected to the controller (12), and
wherein the blocking element (5) actuates the switch (15) in the non-actuated position (18).

10. The work apparatus (1) according to claim 6,
wherein the work apparatus (1) is a cut-off machine and the tool (8) is a cutting wheel.
